(19) United States
(12) Patent Application Publication
(10) Pub. No.: US 2005/0174072 A1
(43) Pub. Date: Aug. 11, 2005

(54) Dynamic focus voltage for a focus mask

(76) Inventors: Richard William Nosker, Princeton, NJ (US); Allan Eugene White, Hightown, NJ (US); Philip Michael Heyman, West Windsor, NJ (US); Istvan Gorog, Lancaster, PA (US)

Correspondence Address: THOMSON LICENSING INC., PATENT OPERATIONS, PO BOX 5312, PRINCETON, NJ, 08543-5312, US

(21) Appl. No.: 10/510,061

(22) PCT Filed: Apr. 2, 2003
(86) PCT No.: PCT/US03/10014

Related U.S. Application Data
(60) Provisional application No. 60/369,920, filed on Apr. 4, 2002.

(51) Int. Cl. G09G 1/04

(52) U.S. Cl. 315/365

(57) ABSTRACT

A dynamic focus voltage generator is provided for a tensioned focus mask of a cathode ray tube of video display. The tensioned focus mask includes spaced apart strands and spaced apart crosswires separated from the strands. A synchronizing signal at a horizontal deflection frequency is used for generating a dynamic focus voltage component that varies in accordance with a position of an electron beam on a screen of the cathode ray tube. A synchronizing signal at a vertical deflection frequency is used for generating a dynamic focus voltage component that varies in accordance with the position of the electron beam on the screen of the cathode ray tube. The time varying voltage components are combined with a direct current voltage component for producing a dynamic focus voltage between the strands and crosswires.

### CROSS-REFERENCE TO RELATED APPLICATIONS

This is a non-provisional application which claims the benefit of provisional application Ser. No. 60/369,920, filed Apr. 4, 2002.

The invention generally relates to the application of a focus voltage to conductors of a focus mask of a color picture tube or a cathode ray tube (CRT).

### BACKGROUND OF THE INVENTION

A color picture tube includes an electron gun for forming and directing three electron beams to a screen of the tube. The screen is located on the inner surface of the faceplate of the tube and is made up of an array of elements of three different color-emitting phosphors. An aperture mask or a shadow mask is interposed between the electron gun and the screen to permit each electron beam to strike only the phosphor elements associated with that beam. A shadow mask is a thin sheet of metal, such as steel, that is contoured to somewhat parallel the inner surface of the tube faceplate. A shadow mask may be either domed or tensioned.

A type of tension mask, called a tension focus mask, includes two sets of conductive elements that are perpendicular to each other and separated by an insulator. Generally, in a tension focus mask, a vertical set of conductive lines or strands is under tension and a set of horizontal conductive elements sometimes known as crosswires overlies the strands. Different voltages are applied to the set of crosswires and to the set of strands, respectively. The focus voltage that is the difference between the voltage applied to the crosswires and that applied to the strands, creates a quadrupole focusing lens in each aperture of the focus mask. The mask apertures are rectangular and are formed between adjacent vertical strands and adjacent horizontal crosswires.

Typically, the distance between the focus mask and the screen measured along the beam path increases as the beam sweeps from the center of the CRT towards the edges. The change in the mask-to-screen spacing along the beam path might lead to an over-focussing of the beam at the periphery of the screen if the focus voltage difference is selected to satisfy the requirements at the center of the screen. For example, in a CRT having 27 inch screen and 110 degrees, the focus voltage difference that produces an acceptable beam spot at the screen center may be different by 30% from that required at the screen edge. It may be desirable to avoid the aforementioned difference in focusing.

In carrying out an inventive feature, the focus voltage difference is made to vary at a horizontal rate with an amplitude that is modulated at a vertical rate. Thereby, advantageously, over-focusing of the beam is prevented.

### SUMMARY OF THE INVENTION

A focus voltage generator, embodying an invention feature, for a tensioned focus mask of a cathode ray tube of video display apparatus has a first plurality of spaced apart strands and a second plurality of spaced apart crosswires separated from the strands. A source of a first signal at a frequency related to a deflection frequency is provided. A waveform generator responsive to the first signal for generating a dynamic focus voltage that varies in accordance with a position of an electron beam on a screen of the cathode ray tube and developed between the strands and crosswires.

### BRIEF DESCRIPTION OF THE DRAWINGS

FIG. 1 is a side view, partially in axial section, of a color picture tube, including a tension focus mask assembly;

FIG. 2 is a perspective view of the tension focus mask assembly of FIG. 1; and

FIG. 3 is a block diagram of a power supply, embodying an inventive feature, for generating a dynamic focus voltage that is coupled to the tension focus mask assembly of FIG. 1.

### DETAILED DESCRIPTION

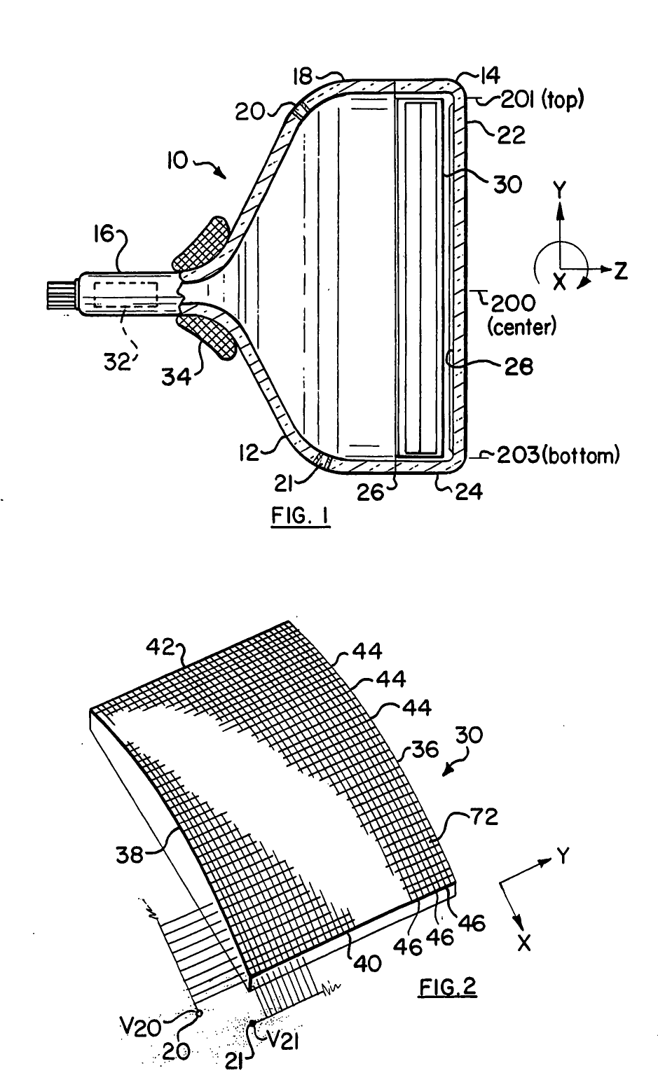

FIG. 1 shows a cathode ray tube 10 having a glass envelope 12. A rectangular panel 14 and a tubular neck 16 are connected by a rectangular funnel 18. Funnel 18 has an internal conductive coating, not shown, that extends from an anode button 20 to a neck 16. Panel 14 includes a viewing faceplate 22 and a peripheral flange or sidewall 24 that is sealed to the funnel 18 by a glass frit 26. A three-color phosphor screen 28 is carried by an inner surface of faceplate 22. Screen 28 is a line screen with the phosphor lines arranged in triads, each triad including a phosphor line of each of the three colors, red-emitting, green-emitting and blue-emitting phosphor lines, R, G and B. A tension focus mask 30 is removably mounted in a predetermined spaced relation to screen 28. An electron gun 32, schematically shown by the dashed lines, is centrally mounted within neck 16. Gun 32 generates three in-line electron beams red, green and blue, not shown, that form a center beam and two side beams, along convergent paths through mask 30 to the screen 28.

A deflection yoke 34 is mounted on funnel. Deflection yoke 34 includes a horizontal deflection winding, not shown, for conducting a horizontal deflection current, not shown, at a horizontal frequency Fh such as, for example, approximately 15,724 Hz and a vertical deflection winding, not shown, for conducting a vertical deflection current, not shown, at a vertical frequency Fv such as 60 Hz. Deflection yoke 34 subjects the three beams to magnetic fields which cause the beams to scan horizontally and vertically in a rectangular raster over screen 28.

In deflection yoke 34, fast scanning occurs in a horizontal direction X and slow scanning occurs in a vertical direction Y. However, the invention is equally applicable to an embodiment, not shown, in which fast scanning occurs in the vertical direction Y and slow scanning occurs in the horizontal direction X.

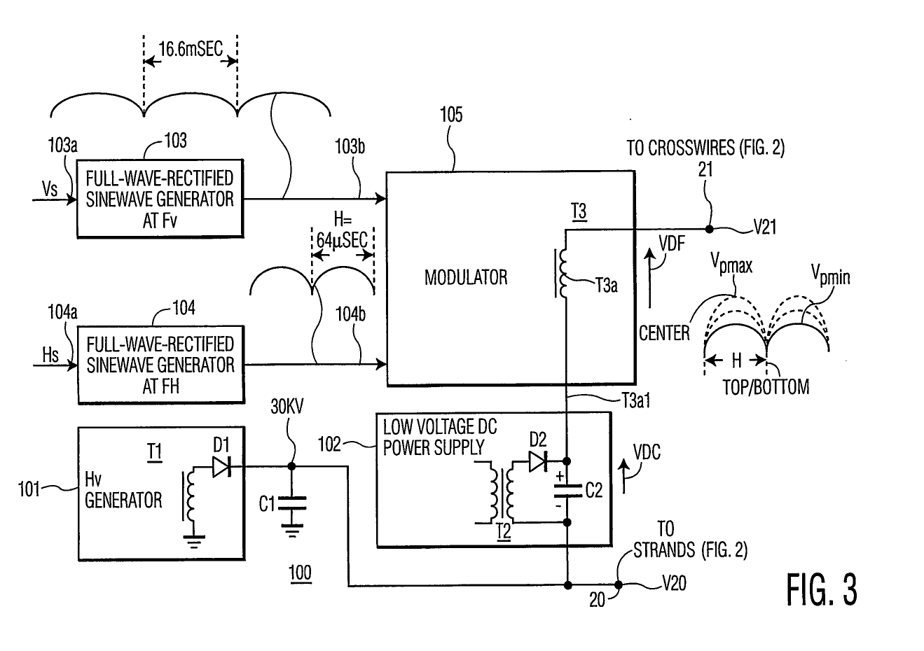

Tension mask 30 is shown in greater detail in FIG. 2. Similar symbols and numerals in FIGS. 1 and 2 indicate similar items or functions. Tension mask 30 of FIG. 2 includes two longs sides 36 and 38 and two short sides 40 and 42. The two long sides 36 and 38 of mask 30 parallel horizontal major axis, X, of tube 10 of FIG. 1.

Tension mask 30 of FIG. 2 includes two sets of conductors: strands 44 that are parallel to central minor axis y and to each other; and crosswires 46, that are parallel to central major axis x and to each other. Strands 44 are flat strips that extend vertically, having a width of about 12 mils, a thickness of approximately 2 mils and a separation or pitch of 0.91 mm. Crosswires 46 have a round cross section, a diameter of about 1 mil and extend horizontally with a separation or pitch of 16 mils. Strands 44 and crosswires 46 are separated from each other in the direction of axis Z of FIG. 1, in a well-known manner, not shown, by suitable insulators. The separation between strands 44 and crosswires 46 in the direction of axis Z is in the order of, for example, 0.675 inch. An example of such arrangement is shown in U.S. Pat. No. 5,646,478, in the names of Nosker et al., entitled UNIAXIAL TENSION FOCUS MASK FOR A COLOR CRT WITH ELECTRICAL CONNECTION MEANS (the Nosker et al., patent).

Strands 44 are electrically coupled to an electrode 20 of FIG. 1 via a first conductive layer, not shown, formed on an interior surface of the glass of CRT 10. A voltage V20 of FIG. 2 of electrode 20 is applied to each strand 44. Similarly, crosswires 46 are electrically coupled to an electrode 21 of FIG. 1 via a second conductor, not shown, formed on an interior surface of the glass of CRT 10. A voltage V21 of FIG. 2 of electrode 21 is applied to each crosswires 46. An example of such arrangement is shown in the Nosker et al., Patent.

In a similar way to that explained in, for example, U.S. Pat. No. 4,464,601, entitled CRT WITH QUADRUPOLAR-FOCUSING COLOR-SELECTION STRUCTURE, in the name of Stanley Bloom, voltages V20 and V21 form electrostatic quadrupolar-focus lens in each aperture such as, for example, an aperture 72. Each aperture 72 is bound by an adjacent pair of crosswires 46 and by an adjacent pair of strands 44.

FIG. 3 is a block diagram of a power supply 100, embodying an inventive feature, for generating dynamic focus voltage V21 that is coupled to crosswires 46 of FIG. 2. A high voltage power supply 101 generates focus voltage V20 at a constant level that is coupled to strands 44 of FIG. 2. Similar symbols and numerals in FIGS. 1, 2 and 3 indicate similar items or functions.

High voltage power supply 101, that may have a similar construction to that of a conventional horizontal deflection circuit output stage, not shown, includes a flyback transformer T1, a rectifier D1 and a filter capacitor C1 for generating direct current (DC) voltage V20 at a high voltage of, for example, 30 kV that is developed at terminal 20. A conventional low voltage power supply 102 produces an alternating current (AC) voltage, not shown, that is transformer-coupled via a transformer T2 to a rectifier D2 for developing a constant DC voltage VDC in a filter capacitor C2. Voltage VDC is summed with voltage V20 and coupled to a terminal T3a1 of winding T3a of a transformer T3 to provide a DC voltage component of voltage V21.

A periodic horizontal sync signal Hs and a periodic vertical sync signal Vs having periods H and V, respectively, are coupled from a source that is not shown to input terminals 104a and 103a, respectively. The source of signals Hs and Vs, not shown, may be conventional and may include a sync separator of a video display that separates signals Hs and Vs from an incoming composite video signals. Separated sync signals Hs and Vs may be time shifted with respect to each other.

Signal Vs is coupled to a waveform generator 103. Generator 103 generates from signal Vs a full-wave rectified-sinewave 103b at a frequency that is equal to vertical frequency Fv. Signal Hs is coupled to a waveform generator 104. Generator 104 generates from signal Hs a full-wave-rectified sinewave 104b at a frequency that is equal to horizontal frequency Fh. Signals 103b and 104b are multiplied in a multiplier or modulator 105 and transformer coupled via transformer T3 to produce a transformer coupled dynamic focus voltage component VDF of voltage V21. Transformers T3 and T2 isolate modulator 105 and power supply 102, respectively, from high voltage V20. Dynamic focus voltage component VDF is a full-wave-rectified sinewave signal at horizontal frequency Fh having peak amplitude that varies at frequency Fv in a full wave-rectified sinewave manner.

When an electron beam EB of FIG. 1 is at a horizontal center of scan line 200 of FIG. 1, that is located at a vertical center of screen 28, the peak value of the sum of voltages VDC and VDF of FIG. 3 is selected to be at a maximum value, for example, 850V. On the other hand, when electron beam EB is at any of the four corners of screen 28, such as at the edges of a scan line 201 of FIG. 1, at a top of screen 28, and at the edges of a scan line 203, at a bottom of screen 28, the peak value of the sum of voltages VDC and VDF of FIG. 3 is at a minimum value, for example, 580V.

In each horizontal line such as, for example, scan line 200 of FIG. 1, the peak value of the sum of voltages VDC and VDF of FIG. 3 is at a maximum value at the horizontal center point, not shown, of scan line 200 of FIG. 1 and at a minimum value at each of the right side and left side ends, not shown, of scan line 200. In this way, a difference between voltages V21 and V20 of FIG. 3 decreases as electron beam EB of FIG. 1 moves away from the center of screen 28, in either the direction of axis X or in the direction of axis Y. On the other hand, the difference between voltages V21 and V20 of FIG. 3 increases as electron beam EB of FIG. 1 moves towards the center of screen 28, in either the direction of axis X or in the direction of axis Y. The difference between voltages V21 and V20 is determined by the geometry of tension mask 30 of FIG. 2, referred to before. It should be understood that the difference between voltages V21 and V20 may be different if different geometry of tension mask 30 was selected.

Dynamic focus voltage arrangement similar to that described in FIG. 3 can be used in an embodiment, not shown, in which transposed scanning is implemented. Transposed scanning is described in, for example, an article entitled “Transposed Scanning: The Way to Realize Super Slim CRTs”, in the names of Krijn, et al.,published in SID June 2001 digest. Transposed scanning is also described in U.S. Pat. No. 4,989,092, in the names of Doyle et al., entitled PICTURE DISPLAY DEVICE USING SCAN DIRECTION TRANSPOSITION.

1. A focus voltage generator for a tensioned focus mask of a cathode ray tube of video display apparatus having a first plurality of spaced apart strands and a second plurality of spaced apart crosswires separated from said strands, comprising:
a source of a first signal at a frequency related to a deflection frequency; and
a waveform generator responsive to said first signal for generating a dynamic focus voltage that varies in accordance with a position of an electron beam on a screen of said cathode ray tube and developed between said strands and crosswires.

2. The focus voltage generator according to claim 1 wherein, at each instant, said dynamic focus voltage is the same between each of said strands and each of said crosswires.

3. The focus voltage generator according to claim 1 wherein said dynamic focus voltage includes a direct current voltage component.

4. The focus voltage generator according to claim 1 wherein said dynamic focus voltage includes a voltage component at a frequency related to a horizontal deflection frequency and a voltage component at a frequency related to a vertical deflection frequency.

5. The focus voltage generator according to claim 1 wherein said waveform generator comprises a full-wave rectified sinewave generator at one of a horizontal deflection frequency and a vertical deflection frequency.
